(19) United States
(12) Patent Application Publication
(10) Pub. No.: US 2022/0114545 A1
(43) Pub. Date: Apr. 14, 2022

(54) METHODS AND SYSTEMS FOR ENSURING ON-TIME DELIVERY (OTD) OF PRODUCT

(71) Applicant: Tata Consultancy Services Limited, Mumbai (IN)

(72) Inventors: Chetan Inderjeet SHETH, Mason, OH (US); Tanuj GUPTA, Cincinnati, OH (US); Swanand Vishwas HALDANKAR, Mason, OH (US); Manish SONI, Iselin, NJ (US)

(73) Assignee: Tata Consultancy Services Limited, Mumbai (IN)

(21) Appl. No.: 17/494,868

(22) Filed: Oct. 6, 2021

Related U.S. Application Data
(60) Provisional application No. 63/090,465, filed on Oct. 12, 2020.

(51) Int. Cl. G06Q 10/08; G06N 20/00

(52) U.S. Cl. CPC G06Q 10/0835; G06N 20/00

(57) ABSTRACT

The disclosure generally relates to methods and systems for ensuring the on-time delivery (OTD) of a product by a manufacturing company. According to the present disclosure, a part persona for each part is generated using a data model, by placing the part as an central entity and the one or more influencing factors of each part that affect the OTD of the product are captured in the part persona. A trained intent and OTD prediction model is built and used to predict an initial intent and an initial OTD for each part, based on the corresponding part persona. Further, the trained intent and OTD prediction model is used to predict a successive intent and a successive OTD for each part, based on the conversations and the events. Hence the OTD of the product is accurately predicted and which is useful to ensuring the OTD of the product.

### PRIORITY CLAIM

This U.S. patent application claims priority under 35 U.S.C. § 119 to: U.S. provisional Patent Application No. 63/090,465, filed on 12 Oct. 2020. The entire contents of the aforementioned application are incorporated herein by reference.

### TECHNICAL FIELD

The disclosure herein generally relates to the field of manufacturing, and, more particularly, to methods and systems for ensuring on-time delivery (OTD) of a product in the manufacturing industry.

### BACKGROUND

Meeting an overall on-time delivery (OTD) of finished products, manufactured products, or goods (herein after referred as ‘products’) to clients is very important for any manufacturing company. Thus, manufacturing companies need to closely monitor respective supply chains for the correct components, in order to manufacture the products on time.

Typical manufacturing processes are complex as the manufacturing company may be dependent on convoluted networks of suppliers, for the sourcing of parts for manufacturing the products. The convoluted networks of suppliers include direct suppliers and indirect suppliers, use different systems that frequently run with a different technological infrastructure and specialized IT systems, to make different purchase orders. Particularly, the sourcing of parts is typically a complex process because multiple IT enterprise systems are involved, the inter-system communications may be difficult due to system incompatibilities. Indeed, certain suppliers may work with conventional supply chain management platforms that can sometimes stand alone and may be off-line. Hence the status information about the sourcing of the parts may be isolated to the respective suppliers, leading to missing valuable time by the manufacturing company for taking a right action to ensure the OTD of the products.

Conventional techniques and platforms that co-relate the provided status information, are limited due to lack of cohesive, ubiquitous nature of interaction, leading to manual data sharing, offline conversations, and untracked escalations. The sourcing of the parts becomes even more complex if more indirect suppliers are involved. Lack of compatibility between systems, poor communications, or poor connectivity leads to technical issues that result in unpredicted supply chain discontinuities that delay sourcing of the parts and can significantly impact the OTD of the products.

### SUMMARY

Embodiments of the present disclosure present technological improvements as solutions to one or more of the above-mentioned technical problems recognized by the inventors in conventional systems.

In an aspect, there is provided a processor-implemented method for ensuring on-time delivery (OTD) of a product, the method comprising the steps of: receiving product details of the product and part details of each of a plurality of parts, wherein the plurality of parts being associated with a manufacturing process of the product; collecting part particulars for each of the plurality of parts, wherein the part particulars for each of the plurality of parts comprising at least one of: supplier data, fulfillment data, buyer data, and inducing data; generating a part persona for each of the plurality of parts, using a data model, based on the part particulars corresponding to each of the plurality of parts; predicting (i) an initial intent for each of the plurality of parts and (ii) an initial OTD for each of the plurality of parts, using a trained intent and OTD prediction model, based on the part persona corresponding to each of the plurality of parts; and ensuring the OTD of the product, based on the initial OTD for each of the plurality of parts.

In another aspect, there is provided a system for ensuring on-time delivery (OTD) of a product, the system comprising: a prediction device connected to one or more client devices and online resources, through a network, wherein the prediction device comprising: a memory storing instructions; one or more Input/Output (I/O) interfaces; and one or more hardware processors coupled to the memory via the one or more I/O interfaces, wherein the one or more hardware processors of the prediction device are configured by the instructions to: receive product details of the product and part details of each of a plurality of parts, wherein the plurality of parts being associated with a manufacturing process of the product; collect part particulars for each of the plurality of parts, wherein the part particulars for each of the plurality of parts comprising at least one of: supplier data, fulfillment data, buyer data, and inducing data; generate a part persona for each of the plurality of parts, using a data model, based on the part particulars corresponding to each of the plurality of parts; predict (i) an initial intent for each of the plurality of parts and (ii) an initial OTD for each of the plurality of parts, using a trained intent and OTD prediction model, based on the part persona corresponding to each of the plurality of parts; and ensure the OTD of the product, based on the initial OTD for each of the plurality of parts.

In yet another aspect, there is provided a computer program product comprising a non-transitory computer readable medium having a computer readable program embodied therein, wherein the computer readable program, when executed on a computing device, causes the computing device to: receive product details of the product and part details of each of a plurality of parts, wherein the plurality of parts being associated with a manufacturing process of the product; collect part particulars for each of the plurality of parts, wherein the part particulars for each of the plurality of parts comprising at least one of: supplier data, fulfillment data, buyer data, and inducing data; generate a part persona for each of the plurality of parts, using a data model, based on the part particulars corresponding to each of the plurality of parts; predict (i) an initial intent for each of the plurality of parts and (ii) an initial OTD for each of the plurality of parts, using a trained intent and OTD prediction model, based on the part persona corresponding to each of the plurality of parts; and ensure the OTD of the product, based on the initial OTD for each of the plurality of parts.

In an embodiment, the prediction device is further configured to: (a) receive at least one of: (i) one or more initial conversations and (ii) one or more initial events, associated with each of the plurality of parts, from the one or more client devices; (b) update the part persona for each of the plurality of parts, based on: (i) the initial intent associated with each of the plurality of parts, (ii) the one or more initial conversations associated with each of the plurality of parts, (iii) the one or more initial events associated with each of the plurality of parts, to obtain a successive part persona for each of the plurality of parts; (c) predict (i) a successive intent for each of the plurality of parts and (ii) a successive OTD for each of the plurality of parts, using the trained intent and OTD prediction model, based on the successive part persona corresponding to each of the plurality of parts; (d) determine a successive OTD of the product, based on the successive OTD for each of the plurality of parts; (e) receive at least one of: (i) one or more successive conversations and (ii) one or more successive events, associated with each part of the plurality of parts, from the one or more client devices; and (f) repeat the steps (b) through (e), by taking at least one of: (i) the one or more successive conversations as the one or more initial conversations, associated with each part, and (ii) the one or more successive events as the one or more initial events associated with each part, until either (i) the one or more initial conversations or one or more successive conversations associated with each part are not present, or (ii) the one or more initial events or one or more successive events associated with each part are not present.

In an embodiment, the part persona for each of the plurality of parts, is generated, using the data model, based on the part data corresponding to each of the plurality of parts, by: identifying a plurality of correlations for each of the plurality of parts, based on the part particulars associated with each of the plurality of parts, and calculating a correlation score for each of the plurality of correlations associated with each of the plurality of parts, using an entropy and information gain function; forming a part influencing matrix for each of the plurality of parts, using (i) the plurality of correlations associated with each of the plurality of parts and (ii) the correlation score for each of the plurality of correlations associated with each of the plurality of parts; identifying one or more high-influence correlations among the plurality of correlations present in the part influencing matrix, based on the correlation score, for each of the plurality of parts, wherein the one or more high-influence correlations indicates more impact on the OTD corresponding to each of the plurality of parts; and generating the part persona for each of the plurality of parts, using the identified one or more high-influence correlations, using the data model.

In an embodiment, the part influencing matrix for each of the plurality of parts, is transmitted to the one or more client devices.

In an embodiment, the trained intent and OTD prediction model is obtained by: receiving, from a historical repository, (i) a plurality of historical part personas associated with each of a plurality of historical parts, wherein the plurality of historical parts are further associated with a historical product (ii) a plurality of historical intents associated with each of the plurality of historical parts, and (iii) a plurality of historical OTDs of each of the plurality of historical parts, wherein the historical OTD of each of the plurality of historical parts is determined based on the corresponding historical intent; and training a Q-Learning (QL) model, with (i) the plurality of historical part personas associated with each of a plurality of historical parts, (ii) the plurality of historical intents associated with each of the plurality of historical parts, and (iii) the plurality of historical OTDs of each of the plurality of historical parts, to obtain the trained intent and OTD prediction model, by: (a) initializing network parameters of the QL model; (b) passing the historical part persona associated with each historical part, at a time, to a QL agent of the QL model, to obtain (i) a predicted intent corresponding to the historical part and (ii) the predicted OTD corresponding to the historical part; (c) minimizing a QL loss function which is defined as: (i) a mean square error difference between the predicted intent corresponding to the historical part and the historical intent corresponding to the historical part, and the mean square error difference between the predicted OTD corresponding to the historical part and the historical OTD corresponding to the historical part; (d) updating the network parameters of the Q-Learning model, based on an output of the QL loss function; and (e) repeating the steps (b) through (d), until the plurality of historical part personas associated with each of the plurality of historical parts, are completed.

In an embodiment, the initial intent predicted for each of the plurality of parts, indicates the progressive update on the OTD of the each of the plurality of parts.

In an embodiment, the initial OTD for each of the plurality of parts, is predicted, based on the initial intent corresponding to each of the plurality of parts.

In an embodiment, the successive OTD for each of the plurality of parts, is predicted based on the successive intent corresponding to each of the plurality of parts.

It is to be understood that both the foregoing general description and the following detailed description are exemplary and explanatory only and are not restrictive of the embodiments of the present disclosure, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles:

FIG. 1 is an exemplary block diagram of a system for ensuring on-time delivery (OTD) of a product, in accordance with some embodiments of the present disclosure.

FIG. 2 is an exemplary block diagram of a prediction device of FIG. 1, in accordance with some embodiments of the present disclosure.

FIG. 3 is an exemplary block diagram of a client device, in accordance with some embodiments of the present disclosure.

FIG. 4 illustrate an exemplary flow diagram of a processor-implemented method for ensuring on-time delivery (OTD) of a product, in accordance with some embodiments of the present disclosure.

FIG. 5 is an exemplary diagram illustrating a graph-based data model for a part persona of a part, in accordance with some embodiments of the present disclosure.

### DETAILED DESCRIPTION OF EMBODIMENTS

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the scope of the disclosed embodiments.

The disclosure is generally directed to computer-implemented methods for integration, analysis, and ensuring of on-time delivery (OTD) of the products by the manufacturing companies. In some embodiments, the disclosed embodiments provide a robust architecture to control manufacturing processes even when they are dependent on complex networks for suppliers with different IT enterprise systems and/or offline (or inaccessible inventory systems) by monitoring part status using part as persona instead of a data point. The disclosed systems and methods may provide means to control the status of sourcing of the parts for manufacturing, even if the suppliers are isolated, and minimize issues that cause missing valuable manufacturing time. Further, certain embodiments of the disclosed systems and methods may also enable the generation of automated early alerts to correct part deficiencies and take actions that minimize manufacture process disruptions to meet and ensure the on-time delivery of the products.

Unlike conventional applications and platforms that co-relate the provided status information and are limited due to lack of cohesive interactions, the disclosed systems and methods may solve system incompatibilities by allowing ubiquitous interaction between the stakeholders, preventing manual data sharing, offline conversations, and/or untracked escalations. For example, certain embodiments of the disclosed systems employ conversation analysis to monitor off-line processes of the suppliers that supply the parts, enabling continuous tracking of the discussions between the suppliers and the manufacturing company. Such embodiments allow integrated tracking status of the parts at various level to maintain the effective supply chain management. Therefore, certain embodiments of disclosed systems and methods may solve compatibility issues during communications between suppliers and buyers of a manufacturing process. For instance, disclosed systems and methods may enable process control using unstructured supply chain conversations and using them with various datapoints collected from the various systems.

The disclosed systems and methods may also predict the on-time delivery of each part based on the part persona of the corresponding part through artificial intelligence methods. Further, the artificial intelligence methods are capable of predicting intent from the part personal for each part or communication exchanges between sellers and buyers. Thus, disclosed systems and methods enable the creation of a centralized monitoring function that improves the technical field of data management. A supply chain manager may source multiple parts from multiple suppliers. It plays an important role to meet an overall on-time delivery of the products. The multiple suppliers may include direct suppliers and indirect suppliers, and the multiple suppliers may be placed at different locations. Hence, disclosed systems and methods are directed to the technical field of data aggregation and collection, particularly for supply chains, through an integrated tracking of supply status of the parts is important for the manufacturing company.

In the conventional supply chain management, the Information Technology (IT) enterprise platforms of the suppliers and the manufacturing company are isolated to each other. Conventional supply chain management platforms may provide proactive alerts, by providing status information about various stages of sourcing the multiple parts. However, the status information about sourcing the multiple parts may be provided by a conventional way of communication, such as emails, manual data sharing and off-line conversations. The conventional applications and platforms that co-relate the provided status information are limited due to lack of cohesive, ubiquitous nature of interaction, leading to untracked escalations. The disclosed systems and methods address these problems by employing the methods for tracking supply status.

The conventional IT enterprise platforms alone may not be helpful, as lot of off-line conversations are required to push the supply of the parts that are critical. But the disclosed systems may monitor off-line processes of the suppliers, following the discussions between the suppliers and the manufacturing company, and tracking status of the parts at various level. Moreover, disclosed systems and methods may apply entropy principles for process controls to improve accuracy of predictions. Hence, disclosed systems and methods may enable ensuring the overall on-time delivery of the product.

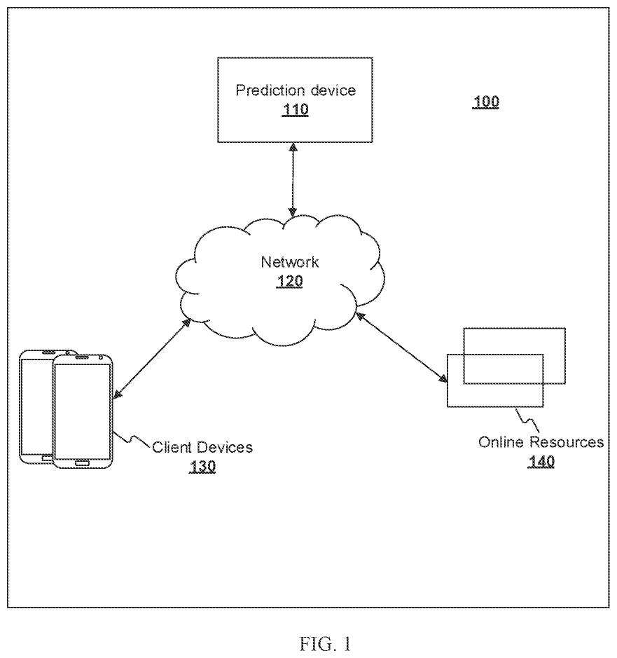

Referring now to the drawings, and more particularly to FIG. 1 through FIG. 5, where similar reference characters denote corresponding features consistently throughout the figures, there are shown preferred embodiments and these embodiments are described in the context of the following exemplary systems and/or methods.

FIG. 1 is an exemplary block diagram of a system 100 for ensuring on-time delivery (OTD) of the product, in accordance with some embodiments of the present disclosure. In an embodiment, the system 100 includes a prediction device 110 connected to one or more client devices 130 and online resources 140 through a network 120. In an embodiment, the system 100 may be present with the manufacturing company that is manufacturing the product. The one or more client devices 130 are associated with one or more clients of the manufacturing company. In an embodiment, the one or more clients include supplier, buyers, other manufacturing companies or other stake holders.

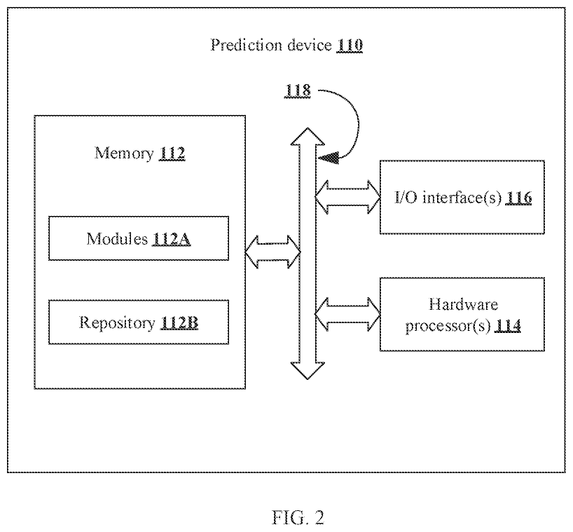

FIG. 2 is an exemplary block diagram of the prediction device 110 of FIG. 1, in accordance with some embodiments of the present disclosure. In an embodiment, the prediction device 110 includes or is otherwise in communication with one or more hardware processors 114, communication interface device(s) or input/output (I/O) interface(s) 116, and one or more data storage devices or memory 112 operatively coupled to the one or more hardware processors 114. The one or more hardware processors 114, the memory 112, and the I/O interface(s) 116 may be coupled to a system bus 118 or a similar mechanism.

The I/O interface(s) 116 may include a variety of software and hardware interfaces, for example, a web interface, a graphical user interface, and the like. The I/O interface(s) 116 may include a variety of software and hardware interfaces, for example, interfaces for peripheral device(s), such as a keyboard, a mouse, an external memory, a plurality of sensor devices, a printer and the like. Further, the I/O interface(s) 116 may enable the prediction device 110 to communicate with other devices, such as web servers and external databases.

The I/O interface(s) 116 can facilitate multiple communications within a wide variety of networks and protocol types, including wired networks, for example, local area network (LAN), cable, etc., and wireless networks, such as Wireless LAN (WLAN), cellular, or satellite. For the purpose, the I/O interface(s) 116 may include one or more ports for connecting a number of computing systems with one another or to another server computer. Further, the I/O interface(s) 116 may include one or more ports for connecting a number of devices to one another or to another server.

The one or more hardware processors 114 may be implemented as one or more microprocessors, microcomputers, microcontrollers, digital signal processors, central processing units, state machines, logic circuitries, and/or any devices that manipulate signals based on operational instructions. Among other capabilities, the one or more hardware processors 114 are configured to fetch and execute computer-readable instructions stored in the memory 112. In the context of the present disclosure, the expressions ‘processors’ and ‘hardware processors’ may be used interchangeably. In an embodiment, the prediction device 110 can be implemented in a variety of computing systems, such as laptop computers, portable computer, notebooks, hand-held devices, workstations, mainframe computers, servers, a network cloud and the like.

The memory 112 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. In an embodiment, the memory 112 includes a plurality of modules 112A and a repository 112B for storing data processed, received, and generated by one or more of the plurality of modules 112A. The plurality of modules 112A may include routines, programs, objects, components, data structures, and so on, which perform particular tasks or implement particular abstract data types.

The plurality of modules 112A may include programs or computer-readable instructions or coded instructions that supplement applications or functions performed by the prediction device 110. The plurality of modules 112A may also be used as, signal processor(s), state machine(s), logic circuitries, and/or any other device or component that manipulates signals based on operational instructions. Further, the plurality of modules 112A can be used by hardware, by computer-readable instructions executed by the one or more hardware processors 114, or by a combination thereof. In an embodiment, the plurality of modules 112A can include various sub-modules (not shown in FIG. 2). Further, the memory 112 may include information pertaining to input(s)/output(s) of each step performed by the processor(s) 114 of the prediction device 110 and methods of the present disclosure.

The repository 112B may include a database or a data engine. Further, the repository 112B amongst other things, may serve as a database or includes a plurality of databases for storing the data that is processed, received, or generated as a result of the execution of the plurality of modules 112A. Although the repository 112B is shown internal to the prediction device 110, it will be noted that, in alternate embodiments, the repository 112B can also be implemented external to the prediction device 110, where the repository 112B may be stored within an external database (not shown in FIG. 2) communicatively coupled to the prediction device 110. The data contained within such external database may be periodically updated. For example, new data may be added into the external database and/or existing data may be modified and/or non-useful data may be deleted from the external database. In one example, the data may be stored in an external system, such as a Lightweight Directory Access Protocol (LDAP) directory and a Relational Database Management System (RDBMS). In another embodiment, the data stored in the repository 112B may be distributed between the prediction device 110 and the external database. In an embodiment, the plurality of modules 112A includes an enterprise resource planner 112A1 and a prediction unit 112A2, connected to each other. In an embodiment, the enterprise resource planner 112A1 may present extremally to the prediction device 110, however communicatively coupled to the prediction device 110.

The one or more client devices 130 may include one or more computing devices configured to perform one or more operations consistent with disclosed embodiments. For example, the one or more client devices 130 may include a desktop computer, a laptop, a server, a mobile device (e.g., tablet, smart phone, etc.), a gaming device, a wearable computing device, or other type of computing device. Each of the one or more client devices 130 may include one or more processors configured to execute software instructions stored in memory. The one or more client devices 130 may include software that when executed by the one or more processors, performs Internet-related communication and content display processes. For instance, the one or more client devices 130 may execute browser software that generates and displays interfaces including content on a display device included in, or connected to, each of the one or more client devices 130. Each of the one or more client devices 130 may execute applications that allows the corresponding client devices 130 to communicate with components over network 120 of the system 100, and generate and display content in interfaces via display devices included in the one or more client devices 130.

The disclosed embodiments are not limited to any particular configuration of the one or more client devices 130. For instance, a client device 130 may be a mobile device that stores and executes mobile applications that provide functions offered by the prediction device 110 and/or online resources 140. In certain embodiments, the client devices 130 may be configured to execute software instructions relating to location services, such as GPS locations. For example, the client device 130 may be configured to determine a geographic location and provide location data and time stamp data corresponding to the location data.

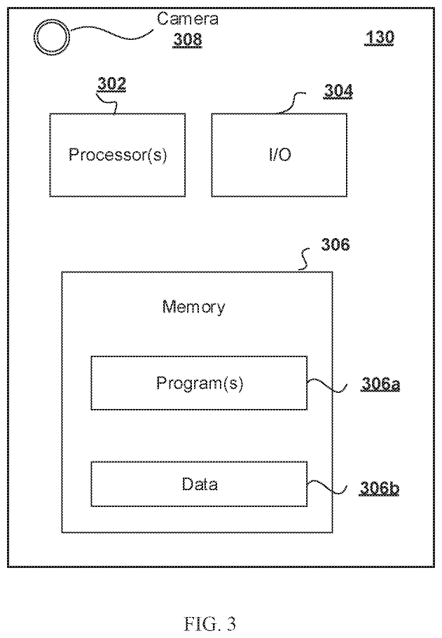

FIG. 3 is an exemplary block diagram of the client device 130 (the one or more client devices), in accordance with some embodiments of the present disclosure. In one embodiment, the client devices 130 may include one or more processors 302, one or more input/output (I/O) devices 304, and one or more memories 306.

The one or more processors 302 may include one or more processing devices, such as mobile device microprocessors. The disclosed embodiments are not limited to any specific type of processor configured in each of the one or more client devices 130. The one or more memories 306 may include one or more storage devices configured to store instructions used by the one or more processors 302 to perform functions related to disclosed embodiments. For example, the memory 306 may be configured with one or more software instructions, such as programs 306a that may perform one or more operations when executed by the one or more processors 302. The disclosed embodiments are not limited to separate programs or computers configured to perform dedicated tasks. For example, the one or more memories 306 may include a single program 306a that performs the functions of the client devices 130, or program 306a may include multiple programs. The one or more memories 306 may also store data 306b associated with the client device 130.

In certain embodiments, the program 306a include applications 306a1 (not shown in FIG. 3) that may be executed by the one or more processors 302 to retrieve and display tracking information about parts, graph-based data models, or product influencing matrices. In certain aspects, the applications 306a1, may be configured to request information from the prediction device 110 or determine the location of the corresponding client devices 130.

In some embodiments, the applications 306a1 may allow to connect with the prediction device 110 allowing access to records of the prediction device 110 or allowing access to functions of the prediction device 110. For example, through the applications 306a1, the client device 130 may retrieve records associated with manufacturing process from prediction device 110. Alternatively, or additionally, through the applications 306a1, the client devices 130 may submit requests associated with the manufacturing process or query account information to the prediction device 110.

The one or more input/output (I/O) devices 304 may include one or more devices configured to allow data to be received and/or transmitted by the one or more client devices 130 and to allow client devices 130 to communicate with other machines and devices, such as other components of the system 100. For example, the one or more I/O devices 304 may include a screen for displaying optical payment methods such as Quick Response (QR) codes or providing information to the user. The one or more I/O devices 304 may also include components for near-field communication (NFC). The one or more I/O devices 304 may also include one or more digital and/or analog devices that allow a user to interact with the client devices 130 such as a touch-sensitive area, buttons, or microphones. The one or more I/O devices 304 may also include one or more accelerometers to detect the orientation and inertia of the client devices 130. The one or more I/O devices 304 may also include other components known in the art for interacting with the prediction device 110.

In some embodiments, the client devices 130 may include a camera 308 that is configured to take images or video and send it to other component of the system 100 via, for example, the network 120.

The components of each client device 130 may be implemented in hardware, software, or a combination of both hardware and software, as may be apparent to those skilled in the art.

The online resources 140 may include one or more servers or storage services provided by an entity such as a provider of website hosting, networking, cloud, or backup services. In some embodiments, the online resources 140 may be associated with hosting services or servers that store web pages of the part suppliers, inventory systems, and/or vendors with web pages containing information about manufacturing processes or parts. In other embodiments, the online resources 140 may be associated with a cloud computing service such as Microsoft Azure™ or Amazon Web Services™. In yet other embodiments, the online resources 140 may be associated with a messaging service, such as, for example, Apple Push Notification Service, Azure Mobile Services, or Google Cloud Messaging. In such embodiments, the online resources 140 may handle the delivery of messages and notifications related to functions of the disclosed embodiments, such as notification of unscheduled items and/or completion messages and notifications.

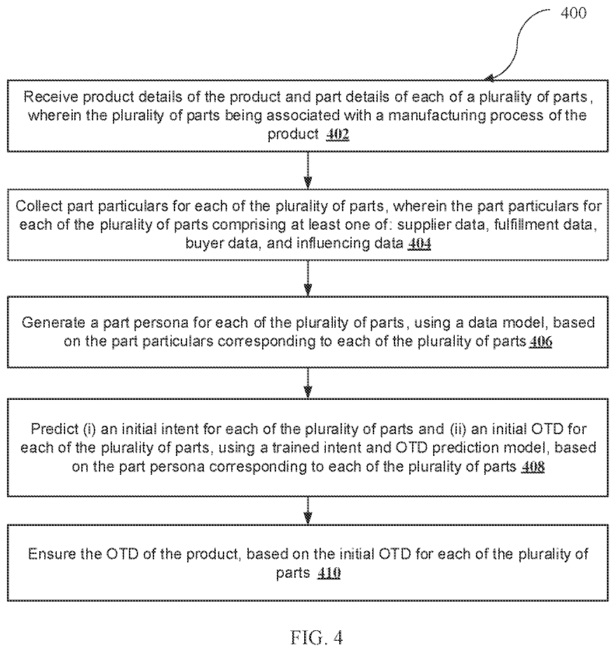

Referring to FIG. 4, components and functionalities of the prediction device 110 and the one or more client devices 130, are described in accordance with an example embodiment of the present disclosure. For example, FIG. 4 illustrate an exemplary flow diagram of a processor-implemented method 400 for ensuring the on-time delivery (OTD) of the product, in accordance with some embodiments of the present disclosure. Although steps of the method 400 including process steps, method steps, techniques or the like may be described in a sequential order, such processes, methods and techniques may be configured to work in alternate orders. In other words, any sequence or order of steps that may be described does not necessarily indicate a requirement that the steps be performed in that order. The steps of processes described herein may be performed in any practical order. Further, some steps may be performed simultaneously, or some steps may be performed alone or independently.

At step 402 of the method 400, the one or more hardware processors 114 of the prediction device 110 of the system 100 are configured to receive product details of the product to be manufactured and part details of each of a plurality of parts. The plurality of parts being associated with a manufacturing process of the product. More specifically, the product is manufactured using the plurality of parts. In an embodiment, the product details of the product and the part details of each of a plurality of parts are received through the enterprise resource planner 112A1. In an embodiment, a user of the manufacturing company may select the product and the plurality of parts associated with the product from the enterprise resource planner 112A1 present the prediction device 110. The plurality of parts associated with the product to be provided by the stakeholders of the manufacturing company, wherein the stakeholders include part suppliers, part buyers, fulfillment leaders, and so on. In an embodiment, one stake holder (such as part supplier) may supply all of the plurality of parts. In another embodiment, one stake holder (such as part supplier) may supply one part or few parts, out of the plurality of parts and hence multiple stake holders (such as part suppliers) may be involved for supplying the plurality of parts.

In some embodiments, the product details include a product name, a product identification number (ID), a product quantity, and so on. In some embodiments, the part details of each part include a part name, a part ID, a part quantity, a part criticality index, a part cost, and so on.

At step 404 of the method 400, the one or more hardware processors 114 of the prediction device 110 of the system 100 are configured to collect part particulars for each of the plurality of parts received at step 402 of the method 400. In an embodiment, the user of the manufacturing company may retrieve the part particulars for each part, from the enterprise resource planner 112A1 present the prediction device 110. The enterprise resource planner 112A1 may be maintained by the manufacturing company which stores and maintains the records of the plurality of parts, received from respective one or more client devices 130. The part particulars for each part include at least one of: supplier data, fulfillment data, buyer data, and inducing data.

The supplier data for each part include details of one or more suppliers. The fulfillment data for each part include details of one or more fulfilment leaders. Similarly, the buyer data for each part include details of one or more buyers. Further, the part particulars for each part include details of one or more source executives and details of one or more supplier executives. Further, the one or more suppliers may include one or more direct suppliers and one or more indirect suppliers that supply the one or more parts to the manufacturing company. In some embodiments, the details of each supplier of the one or more suppliers include a supplier name, a supplier ID, commit date by supplier, supplier contact details, a number of years of operation, a capacity of associated part production, a type of supplier, one or more manufacturing locations of the supplier, one or more warehouse locations of the supplier, a supplier order backlog map of the associated part, and/or a shipping accuracy of the associated part by the supplier. Moreover, in certain embodiments, the supplier contact details may include an e-mail ID of the supplier and one or more contact numbers of the supplier. In such embodiments, a commit date by the supplier is the date before which the supplier is committed to deliver the associated part to the manufacturing company.

The one or more fulfilment leaders may be responsible for fulfilling the sourcing of the one or more parts from the one or more suppliers, to the manufacturing company, through the one or more buyers. The detail of each fulfilment leader of the one or more fulfilment leaders (e.g., delivery leader) may include a name of the fulfilment leader, an ID of the fulfilment leader, contact details of the fulfilment leader, a list of part names handled by the fulfilment leader. The contact details of the fulfilment leader may also include an e-mail ID of the fulfilment leader and one or more contact numbers of the fulfilment leader.

The details of each buyer of the one or more buyers may include a name of the buyer, an ID of the buyer, contact details of the buyer, and/or a list of part names handled by the buyer. Additionally, or alternatively, the contact details of the buyer can include an e-mail ID of the buyer and/or one or more contact numbers of the buyer. In some embodiments, the one or more buyers are responsible to have direct contact with one or more suppliers to buy the one or more parts and to source the one or more parts to the manufacturing company through the one or more fulfilment leaders.

The one or more source executives are responsible to place one or more orders on behalf of the manufacturing company. The orders may be placed to the one or more fulfilment leaders, for example, to source one or more parts. Details of each source executive of the one or more source executives may include a name of the source executive, an ID of the source executive, and contact details of the source executive. Additionally, or alternatively, the contact details of the source executive include an e-mail ID of the source executive and one or more contact numbers of the source executive.

The one or more supplier executives may be associated with the supplier and may receive the one or more orders placed by the one or more source executives, for making the one or more parts, through the one or more buyers and the one or more fulfilment leaders. Details of each supplier executive of the one or more supplier executives may include a name of the supplier executive, an ID of the supplier executive, and/or contact details of the supplier executive. The contact details of the supplier executive include an e-mail ID of the supplier executive and one or more contact numbers of the supplier executive.

The inducing data for each part includes one or more other inducing or important parameters including, a score the associated supplier, a location risk factor of the associated supplier, the on-time delivery score of the associated supplier, weather condition score of the associated supplier, a mode of transport used by the associated supplier, a travel distance from the associated supplier (from warehouses) to the manufacturing company, and so on. For example, the location risk factor may be measured in a 0 to 10 scale, where 10 is the least risky and 0 is riskier (e.g., like places with frequent natural calamity). The score for each supplier is assigned by the prediction device 130, based on supplier's history in delivery punctuality. The delivery punctuality may also be scored from 0 to 10, where percentage of on-time delivery in past scaled from 100 to 10. For example, if supplier has history of 80% times, he was on time then his score is 80/100=8 out of 10.

Table 1 shows exemplary part particulars for part A and part B.

TABLE 1

| Part | Supplier | Part | Supplier | Part | Rain | Delivered |
|---|---|---|---|---|---|---|
| No | name | quantity | Location | Cost | probability % | on time |
| A | abc | 100 | loc1 | 50 | 15 | Yes |
| A | xyz | 200 | loc2 | 45 | 90 | No |
| B | Abc | 40 | Loc1 | 10 | 15 | No |
| B | Xyz | 20 | Loc2 | 10 | 90 | yes |

At step 406 of the method 400, the one or more hardware processors 114 of the prediction device 110 are configured to generate a part persona for each part of the plurality of parts, based on the part particulars corresponding to the associated part, collected at step 404 of the method 400. A data model such as a graph-based data model may be used to generate the part persona for each part based on the part particulars corresponding to the associated part. The detailed process for generating the part persona for each part based on the part particulars is mentioned below.

Firstly, a plurality of correlations associated with each part are identified based on the corresponding part particulars. Each correlation of the one or more correlations defines a relation between two or more part influencing factors identified from the part particulars of the associated part. For example, some of the two or more part influencing factors of the part that may most likely occurs include criticality factor of the associated part, the part quantity, the score of the associated supplier, the location risk factor of the associated supplier, the on-time delivery score of the associated supplier, order backlog of the associated supplier, a shipping accuracy of the associated supplier, an initial commit factor of the associated part, an initial expedite shipping flag factor of the associated part and/or an initial on-time delivery flag factor of the associated part. In some embodiments, the criticality factor of the associated part from the associated part criticality index. For example, an order backlog of the associated supplier may be obtained from the associated supplier order backlog map for the associated part.

An exemplary correlation A is ‘part cost increased if supplied from particular location of the supplier’ where the influencing factors are ‘part cost’ and ‘location of the supplier). Another exemplary correlation B is ‘particular location of the supplier always has a good weather conditions’ (less chances of rain, tolerate atmosphere, and so on, indicated in the form of weather condition score)’. Similarly, another exemplary correlation C is ‘part cost remains same, even if part quantity is increased’. Here the part cost and the part quantity are the influencing factors.

Next a correlation score for each correlation associated with each part is determined, using an entropy and information gain function. An entropy value for each correlation is determined first using the entropy prediction function may be defined as below formula:

E(IF)=−p log₂ p

where E(IF) is the entropy value for the associated correlation and p defines the probability of having specific value for the associated part.

In some embodiments, a total entropy value is determined by adding the entropy values of the plurality of correlations associated with each part. The total entropy value denotes the possibility of on-time delivery of the part to the manufacturing company and in otherwise which are the influencing factors for the associated parts are affecting the on-time delivery of the part.

Then, the correlation score for each correlation is determined using an information gain function. The correlation score is referred as an information gain value for each correlation based on the associated entropy value. The information gain value may indicate how much the information about the associated influence factor present in the correlation is gained over a period. In such embodiments, the information gain function may be defined as below formula:

IG(OTD,X)=E(OTD)−E(OTD|X)

where IG(OTD,X) is the information gain value for associated influencing factor X on the on-time delivery (OTD) of the part, E(OTD) is the total entropy value and E(OTD|X) is the entropy value of the associated influencing factor X.

Further, a part influencing matrix for each part, based on (i) the plurality of correlations corresponding to the associated part and (ii) the correlation score for each of the plurality of correlations corresponding to the associated part. The part influencing matrix for each part includes the plurality correlations along with respective correlation scores. In an embodiment, the prediction device 110 is configured to transmit the part influencing matrix for each of the plurality of parts, to the respective one or more client devices 130.

Table 2 shows exemplary part influencing matrix for part A.

TABLE 2

| | Delivery on time | Correlation |
|---|---|---|
| Correlation Name | (Yes/No) | score |
| Correlation A | Yes | 3 |
| Correlation B | Yes | −2.88 |
| Correlation C | Yes | 0 |

Next, one or more high-influence correlations among the plurality of correlations present in the part influencing matrix for each part is identified, based on the correlation score. More specifically high correlation score for the part indicates high-influence correlation and the low correlation score for the part indicates low-influence correlation. The number of the one or more high-influence correlations among the plurality of correlations is selected based on a correlation threshold score or based on close vicinity of the correlation scores (which shows what correlation factors gained in the information over a period of time). From table 2, the correlation A is the high-influence correlation and the correlation B is the low-influence correlation. The high-influence correlations indicate more impact on the OTD corresponding to the associated part. Lastly, the part persona for each part, is generated, using the one or more high-influence correlations, using the data model. From table 2, both correlation A and correlation C may be considered as high-influence correlations for part A to generate the part persona for part A.

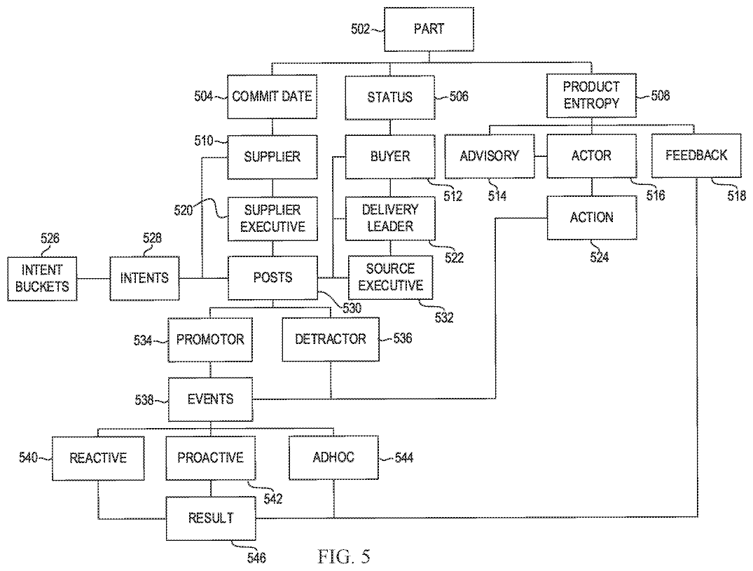

FIG. 5 is an exemplary diagram illustrating a graph-based data model 500 for a part persona of a part, in accordance with some embodiments of the present disclosure. The graph-based data model 500 is only an exemplary data model and such model may be generated with different configurations and/or customizable parameters. For example, the graph-based data model 500 may have a customizable number of edges and nodes. In some embodiments, the graph-based data model 500 may be generated to have at least 30 edges and at least 20 nodes. For example, the graph-based data model 500 may be configured to have 31 edges and 23 nodes.

As shown in FIG. 5, the graph-based data model 500 may include a plurality of entities with different associations. For example, the graph-based data model 500 may include an entity PART (e.g., part 502) that indicates the part name of the associated part. The graph-based data model 500 may also include an entity COMMIT DATE (e.g., commit date 504) that indicates an initial commit date before which the supplier is committed to deliver the associated part to the manufacturing company, an entity SUPPLIER (e.g., supplier 510) indicating the details of the supplier for the associated part, an entity SUPPLIER EXECUTIVE (e.g., supplier executive 520) indicating the details of the supplier executive, an entity STATUS (e.g., status 506) showing a status type of the part from a plurality of status types including ‘pending’, ‘delivered’, ‘yet to be shipped’ and so on, the entity BUYER (e.g., buyer 512) including the details of the buyer or contract admin for the associated part, an entity DELIVERY LEADER (e.g., delivery leader 522) including the details of the delivery leader who is responsible for delivering the associated part, an entity SOURCE EXECUTIVE (e.g., source executive 532) including the details of the source executive.

The graph-based data model 500 may include an entity for PRODUCT ENTROPY (e.g., product entropy 508) defining an entropy value of the product which indicates the status of the product, an entity ACTOR (e.g., actor 516) which may be one of the supplier, or the buyer, or supplier executive, or delivery leader, or source executive, who provide an advisory through the entity ADVISORY (e.g., advisor 514) and provide a feedback in terms of positive or negative through entity FEEDBACK (e.g., feedback 518) based on the entropy value of the product. The actor may provide action through the entity ACTION (e.g., action 524) based on the advisory and feedback.

The graph-based data model 500 may also include an entity INTENT BUCKETS (e.g., intent buckets 526) including one or more intents for the associated part through the entity INTENTS (e.g., intents 528), based on one or more posts raised by the entity POSTS (e.g., posts 530). In an embodiment, each of the one or more intents for the associated part, is assigned with an intent ID and the one or more intents for each part may be stored and logically accessed using a conversation fluid algorithm which is obtained using a long short-term memory (LSTM) based network. The one or more intents and one or more posts may be raised by one of the suppliers, or the buyer, or supplier executive, or delivery leader, or source executive. Every post may be categorized as either a promotor or a detractor based on the events generated from positive and negative action which supply status of the associated part through entities PROMOTOR or DETRACTOR (e.g., promotor 534 and detractor 536 respectively). The entity EVENTS (e.g., events 538) may define one or more events associated with the product, where each event is classified as either reactive, proactive or adhoc through respective entities REACTIVE, PROACTIVE and ADHOC (e.g., reactive 540, proactive 542, and adhoc 544, respectively). An entity RESULT (e.g., result 546) indicates the final status of the associated part which is then feedback to through the EVENT (e.g., events 538).

Moreover, an initial commit factor of the associated part is defined as ‘YES’ at the initial stage. The initial expedite shipping flag factor of the associated part may be defined either as ‘YES’ or ‘No’, based on the associated part criticality index. Thus, the initial on-time delivery flag factor of the associated part is defined as ‘YES’ at the initial stage. Similarly, the posts 530, the intents 528 and events 538 may be initialized with default value at the initial time, as the information related to them many not be available at the initial time and will be provided by the respective stake holder (actor 516) over a period of time.

In summary, the part persona for each part details one or more influencing factors of each part. The graph-based data model 500 may define a relation between the associated part persona, the associated initial intent, and the associated initial OTD of the part. The graph-based data model 500 includes entity part 502 being associated to a commit date 504, a status 506, and a product entropy 508, which may be defined as:

E(IF)=−p log₂ p

The Commit date 504 may be associated with a supplier 510 associated with a supplier executive 520. Status 506 may be associated with a buyer 512, a delivery leader 522, and a source executive 532. Supplier executive 520 may have posts 530 that can be related to intents 528, which are related to intent buckets 526. These posts 530 may be associated with source executive 532. For example, predictive and/or conversation algorithms may couple supplier 510 and buyer 512 through posts 530 between supplier executive 520 and source executive 532.

Posts 530 may be associated with promotor 534 and detractor 536. The promotor 534 may be related to events 538 associated with events categorized as reactive 540, proactive 542, or adhoc 544. Product entropy 508 may be related to an advisor 514, and actor 516, and feedback 518. Further, actor 516 may be associated with an action 524. Product entropy 508 may connect with commit date 504 and status 506 through action 524 that may communicate with events 538. And feedback 518, along reactive 540, proactive 542, and adhoc 544, may contribute to determine a result 546.

At step 408 of the method 400, the one or more hardware processors 114 of the prediction device 110 are configured to predict (i) an initial intent for each of the plurality of parts and (ii) an initial OTD for each of the plurality of parts, using a trained intent and OTD prediction model, based on the part persona corresponding to each of the plurality of parts. The initial intent for each part indicates the intent that may be received in future by the stake holder (such as supplier) in the form of posts or events. The initial OTD for each part indicates a likelihood OTD predicted based on the corresponding initial intent. The trained intent and OTD prediction model is used to predict the initial intent and the initial OTD for each part, much in advance, before actual happenings, based on the one or more influencing factors present in the associated part persona. In an embodiment, the trained intent and OTD prediction model may be present in the prediction unit 112A2 of the prediction device 110.

The trained intent and OTD prediction model is obtained by receiving (i) a plurality of historical part personas associated with each of a plurality of historical parts, (ii) a plurality of historical intents associated with each of the plurality of historical parts, and (iii) a plurality of historical OTDs of each of the plurality of historical parts. The plurality of historical parts is associated with a historical product received in the past. The historical OTD of each of the plurality of historical parts is determined based on the corresponding historical intent. In an embodiment, each of the historical part persona associated with each historical part is generated using the data model as described at step 406 of the method 400. In an embodiment, the plurality of historical part personas, the plurality of historical intents and the plurality of historical OTDs of each historical part of the plurality of historical parts are received from a historical repository that may present in the repository 112B of the prediction device 110.

Next, a reinforcement learning algorithm such as a Q-Learning (QL) model is trained with (i) the plurality of historical part personas associated with each of the plurality of historical parts, (ii) the plurality of historical intents associated with each of the plurality of historical parts, and (iii) the plurality of historical OTDs of each of the plurality of historical parts, to obtain the trained intent and OTD prediction model. The training process of the QL model to obtain the trained intent and OTD prediction model is explained in the below steps step (a) through step (e). At step (a), the network parameters or the model weights of the QL model are randomly initialized. At step (b), the historical part persona associated with each historical part, is passed, at a time, to a QL agent of the QL model, to obtain (i) a predicted intent corresponding to the historical part and (ii) the predicted OTD corresponding to the historical part. The predicted intent corresponding to the historical part is obtained based on the one or more influencing factors present in the associated part persona. The predicted OTD corresponding to the historical part is obtained based on the predicted intent corresponding to the historical part.

At step (c), a QL loss function of the QL model is minimized to update the network parameters. The QL loss function is defined as a sum of: (i) a mean square error difference between the predicted intent corresponding to the historical part and the historical intent corresponding to the historical part, and the mean square error difference between the predicted OTD corresponding to the historical part and the historical OTD corresponding to the historical part. At step (d), the network parameters of the Q-Learning model, are updated if the output of the QL loss function is less than the output of the QL loss function determined in the previous iteration. Finally, at step (e), the steps (b) through (d), are repeated, until the plurality of historical part personas associated with each of the plurality of historical parts, are completed, to obtain the trained intent and OTD prediction model.

The trained intent and OTD prediction model is then used to predict the initial intent for each part of the plurality of parts, based on the one or more influencing parameters in the part influencing matrix associated with the corresponding part persona. Further, the trained intent and OTD prediction model is then used to predict the initial OTD for each part of the plurality of parts, based on the corresponding initial intent.

At step 410 of the method 400, the one or more hardware processors 114 of the prediction device 110 are configured to ensure meeting the OTD of the product, based on the initial OTD for each of the plurality of parts. First the initial OTD of the product is determined based on the initial OTD for each of the plurality of parts. Then the determined initial OTD of the product is compared with the commit date (actual OTD) of the product to ensure meeting the OTD of the product. For example, if the determined initial OTD of the product is well within the limits of the commit date (actual OTD) of the product, then the meeting the OTD of the product is ensured. Else, the prediction device may provide necessary notifications to take precautionary actions to meet the OTD of the product.

Further, the prediction device 110 is configured to predict (i) a successive intent for each of the plurality of parts and (ii) a successive OTD for each of the plurality of parts, wherever there are updates provided by the stake holders (Actor 516 of FIG. 5) such as the part suppliers, part buyers, part fulfillment leaders and so on.

Predicting (i) the successive intent for each of the plurality of parts and (ii) the successive OTD for each of the plurality of parts, by the prediction device 110, is further explained in below steps (a) through (f). At step (a), at least one of: (i) one or more initial conversations and (ii) one or more initial events, associated with each part of the plurality of parts, may be received, from the one or more client devices 130, through the network device 120 of system 100. The one or more initial conversations are the one or more posts messages, or the exchanges (posts 530 of FIG. 5) indicate updates on the part, provided by the respective stake holder such as a supplier (Actor 516 of FIG. 5) for each part. The one or more initial events are the one or more events, or updates (events 538 of FIG. 5) indicate updates on the part, provided by the respective stake holder such as a supplier (Actor 516 of FIG. 5) for each part.

In an embodiment, at one instance, only one or more initial conversations may be received. In another embodiment, at one instance, only one or more initial events may be received. In yet another embodiment, a combination of the one or more initial conversations and the one or more initial events, at one instance.

At step (b), the part persona for each parts, is updated, based on: (i) the initial intent associated with each of the plurality of parts obtained at step 408 of the method 400, (ii) the one or more initial conversations associated with each of the plurality of parts, (iii) the one or more initial events associated with each of the plurality of parts, to obtain a successive part persona for each part of the plurality of parts. As a result of the one or more initial conversations and/or one or more initial events, the plurality of correlations corresponding to the part may be changed and the correlation score for each correlation is again calculated using the entropy and information gain function. Next, the part influencing matrix is updated with the resulted correlations along with the corresponding scores. Further, the high-influence correlations are identified based on the correlation score for each correlation. Lastly, the part persona for each part is updated based on the resulted high-influence correlations and the initial intent associated with the part. At each iteration, the high-influence correlations may change based on how much the information is gained from the one or more initial conversations and/or one or more initial events, over period of time which is measured in terms of the correlations core. As a summary, the one or more influencing factors, and the intents are updated in the successive part persona for each part, based on the one or more conversations, one or more events and the initial intent, using the data model. At step (c), (i) a successive intent for each of the plurality of parts and (ii) a successive OTD for each of the plurality of parts, are predicted using the trained intent and OTD prediction model obtained at step 408 of the method 400, based on the successive part persona corresponding to each of the plurality of parts, in the similar manner explained at step 408 of the method 400. The successive OTD for each of the plurality of parts is predicted based on the successive intent corresponding to each of the plurality of parts.

Then, at step (d), a successive OTD of the product, is determined using on the successive OTD for each of the plurality of parts. At step (e), at least one of: (i) one or more successive conversations and (ii) one or more successive events, associated with each part of the plurality of parts, are received if any, from the one or more client devices 130. The one or more successive conversations are the one or more posts messages, or the exchanges (posts 530 of FIG. 5) indicate updates on the part, provided by the respective stake holder such as a supplier (Actor 516 of FIG. 5) for each part. The one or more successive events are the one or more events, or updates (events 538 of FIG. 5) indicate updates on the part, provided by the respective stake holder such as a supplier (Actor 516 of FIG. 5) for each part. In an embodiment, at one instance, only one or more successive conversations may be received. In another embodiment, at one instance, only one or more successive events may be received. In yet another embodiment, a combination of the one or more successive conversations and the one or more successive events, at one instance.

Finally, at step (f), the steps (b) through (e) are repeated, by taking at least one of: (i) the one or more successive conversations as the one or more initial conversations, associated with each part, and (ii) the one or more successive events as the one or more initial events associated with each part, until either (i) the one or more initial conversations or one or more successive conversations associated with each part are not present, or (ii) the one or more initial events or one or more successive events associated with each part are not present. Hence the OTD of each part and the OTD of the product is predicted continuously wherever there is a post, conversation or the update about the part. Further, the part persona for each part is updated wherever there is a post, conversation or the update about the part and the one or more influencing factors are updated in the corresponding part persona and send to the respective one or more client devices 130 for further action.

Further, the initial intent for each part obtained at step 408 of the method 400 and the successive intents obtained are updated in the associated part persona (intent buckets 526 of FIG. 5). In an embodiment, the initial intent for each part obtained at step 408 of the method 400 and the successive intents are assigned with unique ID and stored using the conversation fluid algorithm which is obtained using the long short-term memory (LSTM) based network. Hence the OTD of each part and the OTD of the product is predicted continuously, to ensure meeting the OTD of the product.

In accordance with the embodiment of the present disclosure, the prediction device 110 accurately ensure the on-time delivery of the products by predicting the on-time delivery of each part of the plurality of parts associated with the product. The part persona for each part is generated continuously, by keeping the part as the central entity not as the data point, which helps in predicting the on-time delivery of each part of the plurality of parts associated with the product. The part particulars for each part is collected from time to time, from the respective client devices, by the system 100, irrespective of the nature, location, software/hardware capabilities of the clients. Hence the system 100 is robust. The system 100 of the present disclosure also provide a platform for integration, analysis, keeping track of parts delivery, monitoring the manufacturing process, apart from ensuring of on-time delivery (OTD) of the products.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

It is to be understood that the scope of the protection is extended to such a program and in addition to a computer-readable means having a message therein; such computer-readable storage means contain program-code means for implementation of one or more steps of the method, when the program runs on a server or mobile device or any suitable programmable device. The hardware device can be any kind of device which can be programmed including e.g. any kind of computer like a server or a personal computer, or the like, or any combination thereof. The device may also include means which could be e.g. hardware means like e.g. an application-specific integrated circuit (ASIC), a field-programmable gate array (FPGA), or a combination of hardware and software means, e.g. an ASIC and an FPGA, or at least one microprocessor and at least one memory with software modules located therein. Thus, the means can include both hardware means and software means. The method embodiments described herein could be implemented in hardware and software. The device may also include software means. Alternatively, the embodiments may be implemented on different hardware devices, e.g. using a plurality of CPUs.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer readable medium can be any apparatus that can comprise, store, communicate, propagate, or transport the program for use by or in connection with the instruction execution system, apparatus, or device.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims (when included in the specification), the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A processor-implemented method for ensuring on-time delivery (OTD) of a product, the method comprising the steps of:
receiving, via one or more hardware processors, product details of the product and part details of each of a plurality of parts, wherein the plurality of parts being associated with a manufacturing process of the product;
collecting, via the one or more hardware processors, part particulars for each of the plurality of parts, wherein the part particulars for each of the plurality of parts comprising at least one of: supplier data, fulfillment data, buyer data, and inducing data;
generating, via the one or more hardware processors, a part persona for each of the plurality of parts, using a data model, based on the part particulars corresponding to each of the plurality of parts;
predicting, via the one or more hardware processors, (i) an initial intent for each of the plurality of parts and (ii) an initial OTD for each of the plurality of parts, using a trained intent and OTD prediction model, based on the part persona corresponding to each of the plurality of parts; and
ensuring, via the one or more hardware processors, the OTD of the product, based on the initial OTD for each of the plurality of parts.

2. The method of claim 1, further comprising:
(a) receiving at least one of: (i) one or more initial conversations and (ii) one or more initial events, associated with each of the plurality of parts, from the one or more client devices;
(b) updating the part persona for each of the plurality of parts, based on: (i) the initial intent associated with each of the plurality of parts, (ii) the one or more initial conversations associated with each of the plurality of parts, (iii) the one or more initial events associated with each of the plurality of parts, to obtain a successive part persona for each of the plurality of parts;
(c) predicting (i) a successive intent for each of the plurality of parts and (ii) a successive OTD for each of the plurality of parts, using the trained intent and OTD prediction model, based on the successive part persona corresponding to each of the plurality of parts;
(d) determining a successive OTD of the product, based on the successive OTD for each of the plurality of parts;
(e) receiving at least one of: (i) one or more successive conversations and (ii) one or more successive events, associated with each part of the plurality of parts, from the one or more client devices; and
(f) repeating the steps (b) through (e), by taking at least one of: (i) the one or more successive conversations as the one or more initial conversations, associated with each part, and (ii) the one or more successive events as the one or more initial events associated with each part, until either (i) the one or more initial conversations or one or more successive conversations associated with each part are not present, or (ii) the one or more initial events or one or more successive events associated with each part are not present.

3. The method of claim 1, wherein generating the part persona for each of the plurality of parts, using the data model, based on the part data corresponding to each of the plurality of parts, comprising:
identifying a plurality of correlations for each of the plurality of parts, based on the part particulars associated with each of the plurality of parts, and calculating a correlation score for each of the plurality of correlations associated with each of the plurality of parts, using an entropy and information gain function;
forming a part influencing matrix for each of the plurality of parts, using (i) the plurality of correlations associated with each of the plurality of parts, and (ii) the correlation score for each of the plurality of correlations associated with each of the plurality of parts;
identifying one or more high-influence correlations among the plurality of correlations present in the part influencing matrix, based on the correlation score, for each of the plurality of parts, wherein the one or more high-influence correlations indicates more impact on the OTD corresponding to each of the plurality of parts; and
generating the part persona for each of the plurality of parts, using the identified one or more high-influence correlations, using the data model.

4. The method of claim 3, wherein the part influencing matrix for each of the plurality of parts, is transmitted to the one or more client devices.

5. The method of claim 1, wherein the trained intent and OTD prediction model is obtained by:
receiving, from a historical repository, (i) a plurality of historical part personas associated with each of a plurality of historical parts, wherein the plurality of historical parts are further associated with a historical product (ii) a plurality of historical intents associated with each of the plurality of historical parts, and (iii) a plurality of historical OTDs of each of the plurality of historical parts, wherein the historical OTD of each of the plurality of historical parts is determined based on the corresponding historical intent; and
training a Q-Learning (QL) model, with (i) the plurality of historical part personas associated with each of a plurality of historical parts, (ii) the plurality of historical intents associated with each of the plurality of historical parts, and (iii) the plurality of historical OTDs of each of the plurality of historical parts, to obtain the trained intent and OTD prediction model, by:
(a) initializing network parameters of the QL model;
(b) passing the historical part persona associated with each historical part, at a time, to a QL agent of the QL model, to obtain (i) a predicted intent corresponding to the historical part and (ii) the predicted OTD corresponding to the historical part;
(c) minimizing a QL loss function which is defined as: (i) a mean square error difference between the predicted intent corresponding to the historical part and the historical intent corresponding to the historical part, and the mean square error difference between the predicted OTD corresponding to the historical part and the historical OTD corresponding to the historical part;
(d) updating the network parameters of the Q-Learning model, based on an output of the QL loss function; and
(e) repeating the steps (b) through (d), until the plurality of historical part personas associated with each of the plurality of historical parts, are completed.

6. The method of claim 1, wherein the initial intent predicted for each of the plurality of parts, indicates the progressive update on the OTD of the each of the plurality of parts.

7. The method of claim 1, wherein the initial OTD for each of the plurality of parts is predicted based on the initial intent corresponding to each of the plurality of parts.

8. The method of claim 2, wherein the successive OTD for each of the plurality of parts is predicted based on the successive intent corresponding to each of the plurality of parts.

9. A system for ensuring on-time delivery (OTD) of a product, the system comprising:
a prediction device connected to one or more client devices and online resources, through a network, wherein the prediction device comprising:
a memory storing instructions;
one or more Input/Output (I/O) interfaces; and
one or more hardware processors coupled to the memory via the one or more I/O interfaces, wherein the one or more hardware processors of the prediction device are configured by the instructions to:
receive product details of the product and part details of each of a plurality of parts, wherein the plurality of parts being associated with a manufacturing process of the product;
collect part particulars for each of the plurality of parts, wherein the part particulars for each of the plurality of parts comprising at least one of: supplier data, fulfillment data, buyer data, and inducing data;
generate a part persona for each of the plurality of parts, using a data model, based on the part particulars corresponding to each of the plurality of parts;
predict (i) an initial intent for each of the plurality of parts and (ii) an initial OTD for each of the plurality of parts, using a trained intent and OTD prediction model, based on the part persona corresponding to each of the plurality of parts; and
ensure the OTD of the product, based on the initial OTD for each of the plurality of parts.

10. The system of claim 9, wherein the one or more hardware processors of the prediction device, are further configured to:
(a) receive at least one of: (i) one or more initial conversations and (ii) one or more initial events, associated with each of the plurality of parts, from the one or more client devices;
(b) update the part persona for each of the plurality of parts, based on: (i) the initial intent associated with each of the plurality of parts, (ii) the one or more initial conversations associated with each of the plurality of parts, (iii) the one or more initial events associated with each of the plurality of parts, to obtain a successive part persona for each of the plurality of parts;
(c) predict (i) a successive intent for each of the plurality of parts and (ii) a successive OTD for each of the plurality of parts, using the trained intent and OTD prediction model, based on the successive part persona corresponding to each of the plurality of parts;
(d) determine a successive OTD of the product, based on the successive OTD for each of the plurality of parts;
(e) receive at least one of: (i) one or more successive conversations and (ii) one or more successive events, associated with each part of the plurality of parts, from the one or more client devices; and
(f) repeat the steps (b) through (e), by taking at least one of: (i) the one or more successive conversations as the one or more initial conversations, associated with each part, and (ii) the one or more successive events as the one or more initial events associated with each part, until either (i) the one or more initial conversations or one or more successive conversations associated with each part are not present, or (ii) the one or more initial events or one or more successive events associated with each part are not present.

11. The system of claim 9, wherein the one or more hardware processors of the prediction device, are configured to generate the part persona for each of the plurality of parts, using the data model, based on the part data corresponding to each of the plurality of parts, by:
identifying a plurality of correlations for each of the plurality of parts, based on the part particulars associated with each of the plurality of parts, and calculating a correlation score for each of the plurality of correlations associated with each of the plurality of parts, using an entropy and information gain function;
forming a part influencing matrix for each of the plurality of parts, using (i) the plurality of correlations associated with each of the plurality of parts and (ii) the correlation score for each of the plurality of correlations associated with each of the plurality of parts;
identifying one or more high-influence correlations among the plurality of correlations present in the part influencing matrix, based on the correlation score, for each of the plurality of parts, wherein the one or more high-influence correlations indicates more impact on the OTD corresponding to each of the plurality of parts; and
generating the part persona for each of the plurality of parts, using the identified one or more high-influence correlations, using the data model.

12. The system of claim 11, wherein the one or more hardware processors of the prediction device, are configured to transmit the part influencing matrix for each of the plurality of parts, to the one or more client devices.

13. The system of claim 9, wherein the one or more hardware processors of the prediction device, are configured to obtain the trained intent and OTD prediction model, by:
receiving, from a historical repository, (i) a plurality of historical part personas associated with each of a plurality of historical parts, wherein the plurality of historical parts are further associated with a historical product (ii) a plurality of historical intents associated with each of the plurality of historical parts, and (iii) a plurality of historical OTDs of each of the plurality of historical parts, wherein the historical OTD of each of the plurality of historical parts is determined based on the corresponding historical intent; and
training a Q-Learning (QL) model, with (i) the plurality of historical part personas associated with each of a plurality of historical parts, (ii) the plurality of historical intents associated with each of the plurality of historical parts, and (iii) the plurality of historical OTDs of each of the plurality of historical parts, to obtain the trained intent and OTD prediction model, by:
(a) initializing network parameters of the QL model;
(b) passing the historical part persona associated with each historical part, at a time, to a QL agent of the QL model, to obtain (i) a predicted intent corresponding to the historical part and (ii) the predicted OTD corresponding to the historical part;
(c) minimizing a QL loss function which is defined as: (i) a mean square error difference between the predicted intent corresponding to the historical part and the historical intent corresponding to the historical part, and the mean square error difference between the predicted OTD corresponding to the historical part and the historical OTD corresponding to the historical part;
(d) updating the network parameters of the Q-Learning model, based on an output of the QL loss function; and
(e) repeating the steps (b) through (d), until the plurality of historical part personas associated with each of the plurality of historical parts, are completed.

14. The system of claim 9, wherein the initial intent predicted for each of the plurality of parts, indicates the progressive update on the OTD of the each of the plurality of parts.

15. The system of claim 9, wherein the one or more hardware processors of the prediction device, are configured to predict the initial OTD for each of the plurality of parts, based on the initial intent corresponding to each of the plurality of parts.

16. The system of claim 10, wherein the one or more hardware processors of the prediction device, are configured to predict the successive OTD for each of the plurality of parts, based on the successive intent corresponding to each of the plurality of parts.

17. A computer program product comprising a non-transitory computer readable medium having a computer readable program embodied therein, wherein the computer readable program, when executed on a computing device, causes the computing device to:
receive product details of the product and part details of each of a plurality of parts, wherein the plurality of parts being associated with a manufacturing process of the product;
collect part particulars for each of the plurality of parts wherein the part particulars for each of the plurality of parts comprising at least one of: supplier data, fulfillment data, buyer data, and inducing data;
generate a part persona for each of the plurality of parts, using a data model, based on the part particulars corresponding to each of the plurality of parts;
predict (i) an initial intent for each of the plurality of parts and (ii) an initial OTD for each of the plurality of parts, using a trained intent and OTD prediction model, based on the part persona corresponding to each of the plurality of parts; and
ensure the OTD of the product, based on the initial OTD for each of the plurality of parts.

18. The computer program product of claim 17, wherein the computer readable program, when executed on the computing device, further causes the computing device to:
(a) receive at least one of: (i) one or more initial conversations and (ii) one or more initial events, associated with each of the plurality of parts, from the one or more client devices;
(b) update the part persona for each of the plurality of parts, based on: (i) the initial intent associated with each of the plurality of parts, (ii) the one or more initial conversations associated with each of the plurality of parts, (iii) the one or more initial events associated with each of the plurality of parts, to obtain a successive part persona for each of the plurality of parts;
(c) predict (i) a successive intent for each of the plurality of parts and (ii) a successive OTD for each of the plurality of parts, using the trained intent and OTD prediction model, based on the successive part persona corresponding to each of the plurality of parts;
(d) determine a successive OTD of the product, based on the successive OTD for each of the plurality of parts;
(e) receive at least one of: (i) one or more successive conversations and (ii) one or more successive events, associated with each part of the plurality of parts, from the one or more client devices; and
(f) repeat the steps (b) through (e), by taking at least one of: (i) the one or more successive conversations as the one or more initial conversations, associated with each part, and (ii) the one or more successive events as the one or more initial events associated with each part, until either (i) the one or more initial conversations or one or more successive conversations associated with each part are not present, or (ii) the one or more initial events or one or more successive events associated with each part are not present.
